(19) United States
(12) Patent Application Publication
(10) Pub. No.: US 2005/0095424 A1
(43) Pub. Date: May 5, 2005

(54) Fibrous rebar with hydraulic binder

(76) Inventor: Alvin Dean Thompson, St. Joseph, MO (US)

Correspondence Address: SHUGHART THOMSON & KILROY, PC, 120 WEST 12TH STREET, KANSAS CITY, MO, 64105, US

(21) Appl. No.: 10/700,247

(22) Filed: Nov. 3, 2003

(51) Int. Cl. B32B 15/14

(52) U.S. Cl. 428/364

(57) ABSTRACT

A structural rebar comprising an elongated fibrous reinforcing member having a hydraulic binder and optionally chopped fibers embedded and dispersed therein.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention is directed generally to structural reinforcing members, and more particularly to a rebar comprised of fiberglass and cement.

### BACKGROUND OF THE INVENTION

Concrete and other masonry or cementitious materials have high compressive strength but relatively low tensile strength. Thus, when concrete is employed as a structural member, it is conventional to incorporate reinforcing members to enhance the tensile strength of the structure. The reinforcing members are usually comprised of a rigid rod or bar, such as a steel rod or bar. Such reinforcing members are typically referred to as “rebar.”

Unfortunately, steel and other metals are susceptible to oxidation. In addition, such materials are quite rigid prior to use so that the placement of such reinforcing members can be difficult and time-intensive. As a result, conventional metal rebar must be cut into pieces in order to form a “criss-cross” or other desired pattern.

One possible solution is to use glass fiber formulations as structural rebar in conjunction with a thermoplastic resin. For example, U.S. Pat. No. 6,048,598 to Bryan, III et al. discloses a twisted rope rebar having individual fibers bound to each other by a thermosetting resin. U.S. Pat. No. 5,580,642 to Okamoto et al. discloses a reinforcing member comprised of reinforcing fibers and thermoplastic fibers. U.S. Pat. Nos. 5,593,536 and 5,626,700 to Kaiser disclose an apparatus for forming reinforcing structural rebar including a combination of pultrusion and SMC (sheet molding compound). The modified pultrusion produces a rebar having a core of thermoset resin reinforcing material and an outer sheet molding compound. U.S. Pat. No. 5,077,133 to Kakihara et al. proposes an inner filament bundle layer spirally wound around a fiber-reinforced core, a plurality of intermediate filament bundles oriented axially along the core, and an outer filament bundle spirally wound around the core and the other bundles. U.S. Pat. No. 4,620,401 to L'Esperance et al. proposes a fiber reinforced thermosetting resin core and a plurality of continuous fibers helically wound around the core and impregnated with the thermosetting resin. Jackson, U.S. Pat. No. 2,425,883 discloses a rod or bar formed of fine glass fibers with a pheonolic resin cured under heat.

Despite these advances, there remains a need to provide an improved structural rebar that overcomes the disadvantages and complexities of the prior art.

### BRIEF SUMMARY OF THE INVENTION

An object of the present invention is to provide a reinforcing member or rebar that has decreased susceptibility to oxidation.

Another object of the present invention is to provide a reinforcing member or rebar that is lightweight, flexible, and easy to use.

Still another object of the present invention is to provide a reinforcing member that does need to employ a thermosetting resin.

In accordance with the foregoing, the present invention is directed to elongated structural rebar for reinforcing concrete material comprising a fibrous reinforcing member having a plurality of organic or inorganic fibers and a hydraulic binder embedded and dispersed within the fibrous reinforcing member.

In another aspect of the present invention, a method of constructing a structural rebar for reinforcing concrete is provided. The method includes providing a fibrous reinforcing member having a plurality of fibers, and embedding and dispersing a hydraulic binder within the fibrous reinforcing member.

In still another aspect of the present invention, a method for reinforcing concrete and like materials is provided. The method includes providing an elongated structural rebar comprised of a fibrous reinforcing member having a plurality of fibers and a hydraulic binder embedded and dispersed within the fibrous reinforcing member; providing a wetted cement adjacent to said elongated structural rebar; and permitting the wetted cement to dry into concrete that is reinforced by said rebar.

### BRIEF DESCRIPTION OF THE DRAWINGS

FIG. 1A is a perspective view of a portion of the structural rebar in accordance with a first embodiment of the present invention.

FIG. 1B shows a cross-section of the rebar shown in FIG. 1A taken through line 1B-1B.

FIG. 1C is an exploded view of the rebar of the present invention prior to construction showing the fibrous member, hydraulic binder, and chopped fibers used to form the rebar.

FIG. 1D illustrates the fibrous member and hydraulic shown FIG. 1C being rolled together to form the rebar illustrated in FIG. 1A.

FIG. 2A illustrates a structural rebar in accordance with a second embodiment of the present invention.

FIG. 2B is a cross-section of the rebar shown in FIG. 2A taken through line 2B-2B.

FIG. 2C is an exploded view of the rebar shown in FIG. 2A prior to construction with an unfolded outer fibrous member and five internal fibrous members.

FIG. 3A illustrates a structural rebar in accordance with a third embodiment of the present invention.

FIG. 3B is a cross section of the rebar shown in FIG. 3A taken through line 3B-3B.

FIG. 4 illustrates the use of the rebar of the present invention to form a rope-like reinforcing structure.

### DETAILED DESCRIPTION OF THE PREFERRED EMBODIMENT

The present invention is directed to a structural rebar for reinforcing concrete comprised of a fibrous reinforcing member having a plurality of elongated fibers and a hydraulic binder embedded and dispersed therein. Chopped fibers are optionally dispersed and embedded within the rebar. During use, the hydraulic binder of the rebar is moistened with an external source of water and/or the surrounding wetted cement itself. As such, the rebar itself becomes an integral part of the surrounding concrete as it dries.

The fibers of the fibrous reinforcing member used in the rebar of the present invention are comprised of any suitable organic or inorganic material. Suitable materials include, but are not limited to fiberglass, graphite, carbon, aramid (Kevlar), filaments of polypropylene or polyester, combinations of these filament materials, and the like. A combination of these filament materials may be used based on their different mechanical properties to produce an array of products having different hardness and flexibility.

In the preferred embodiment, the fibers of the fibrous reinforcing member are comprised of fiberglass. Fiberglass generally refers to glass that has been extruded into extremely fine filaments. These filaments vary in diameter and are generally measured in microns. The fiberglass fibers of the present invention may include a number of commercially available types of fiberglass, e.g. types of fiberglass, e.g. types A, C, D, E (electrical) and S (special). The tensile modulus, tenacity, moisture content, and elongation at break of the fibers will vary depending on the type of fiber utilized. The fibers preferably have the desirable properties of resistance to most acids and alkalis, are unaffected by bleaches and solvents, have resistance to environmental conditions such as mildew and sunlight, and also offer high resistance to abrasion and to aging.

The fibrous reinforcing member of the present invention is constructed using methods well known to those skilled in the fiber art. Typically, the fibrous reinforcing member is comprised of rovings, a collection of bundles of continuous filaments in a strand.

The fibrous reinforcing member of the present invention may incorporate the rovings in any suitable manner well known to those skilled in the fiber art. For example, the rovings may be chopped into short strands (typically ¼ or ½ inch) arranged in a random pattern and held together with a binder so as to create a chopped strand mat. The rovings may alternatively be used in a continuous strand mat in which very long individual fibers form a regular crossed pattern and are loosely held together with a binder. Typically the mats have a “coarse” or “woven” side and a “smooth” or “finished side” in which the fibers are provided in bundles arranged in a predetermined orientation. The rovings may also be incorporated into a wide variety of weaves. Such weaves include, but are not limited to bias, plain, twill, leno, heat set, long shaft satin, plain satin, basket, unidirectional and mock-leno. Lastly, the rovings may also be oriented in a straight line and then sewn together to form a knitted material.

It will be appreciated to those skilled in the art that the fiberglass of the fibrous reinforcing member can have a number of fiber orientations. These orientations include but are not limited to the following orientations: 0° unidirectional, 90° unidirectional, +45/−45− double bias, °0°/90° biaxial longitudinal/transverse, °0°/90°/45° triaxial, 0°/+45°/−45° longitudinal triaxial, +45°/90°/−45° transverse triaxial, 0°/+45°/90°/−45° quadraxial, 0°/−45°/90°/+45° quadraxial and the like.

It will be further appreciated that the fibrous member may incorporate a sizing, which is determined by the particular application for the structural member. One preferred type of sizing involves treating the fiberglass with alkaline-resistant or acid chemicals well known to those skilled in the art. The fiberglass may also be treated with a fluorination process well known to those skilled in the art so that the fibrous member is substantially non-biodegradable.

Preferably, the fibrous reinforcing member employed is an alkaline-resistant (“AR” or “A”) or “E” fiberglass material with a plain weave, chopped strand, or knitted fabric. A most preferred fibrous reinforcing member is commercially available from Owens Corning as product Nos. CM1708, CDM1208, CDM2508, CDBM 3408, CM1708, and DBM 1708. Other suitable materials for the fibrous reinforcing member include: (1) CDM1208, a 12-ounce 0°/90° knitted material, and (2) CM1708, a unidirectional 12-ounce material with a mat from Saint-Gobain Vetrotex America (Wichita Falls, Tex.) under the name CEM FILE.

The fibrous reinforcing member of the present invention may also have a veil overlying at least a portion of the member. The veil is typically an ultrathin mat composed of organic fibers as well as of glass fibers used primarily in corrosion barriers. A suitable veil comprises a nylon stocking that is placed over the fibrous reinforcing member.

As discussed above, the rebar of the present invention also comprises a hydraulic binder. The term “hydraulic binder” as used in the present invention includes all types of hydraulic materials, such as hydraulic cement. The hydraulic cement is preferably in powder form at the solid state, dry, which, once mixed with water, provides plastic mixtures able to set and harden. The hydraulic cement may be selected from all types of Portland cement (e.g., ordinary Portland cement, white Portland cement, coloured Portland cement, Portland blast-furnace cement, Portland fly-ash cement, Portland pozzolana cement, low-heat Portland cement and rapid-hardening Portland cement, high early strength Portland cement, ultra high early strength Portland cement, Portland blast-furnace slag cement, moderate heat Portland cement), as well as fly ash cement, sulfate resisting cement, blast furnace cement, aluminum sulphoaluminate cement, calcium alumino ferrite cement, low alkali cement, aluminous cement, and white cement, blended cement (e.g. pozzolanic cement), slag cement, or other types.

Additional binder replacing materials, such as fly ash, silica fume, volcanic ash, zeolite powder, artificial pozzolans, metakaolin, slag, gypsum, calcium-increased liquid slag, phosphorus slag may also be used in the present invention. Typically, about 20% to about 50% by weight of the hydraulic cement can be replaced by an equal quantity of potential hydraulic binder materials. The quantities replaced are decided according to the fineness and variety of the materials used.

Conventional admixtures in cement technology, such as set accelerators or retarders, frost protection agents, pigments, and the like, may also be present in the hydraulic binder of the invention.

It will be further understood that various conventional additives such as dyes, fillers, ultraviolet stabilizers, antioxidants and the like can be incorporated in the rebar of the present invention.

The rebar of the present invention comprises both a fibrous reinforcing member and a hydraulic binder embedded and dispersed therein. During use, the structural rebar of the present invention is placed into a wetted cement mixture for use as a reinforcing member. The moisture from the wet cement mixture and/or an external source moves into and is absorbed by the structural rebar, thereby wetting the hydraulic binder that is embedded and dispersed in the fibrous reinforcing member of the rebar. The hydraulic binder dries and forms a bond, not only with the fibers of the fibrous reinforcing member, but also with the surrounding concrete. As a result, the rebar of the present invention creates fewer voids or spaces at the junction between the rebar and the surrounding concrete. The rebar of the present invention also maintains its placement within the concrete in an improved manner.

The rebar of the present invention has many other desirable properties. While conventional metal rebar must be cut and positioned in pattern (e.g., a criss-cross pattern), the rebar of the present invention can be manipulated to form a desired pattern (e.g., a zig-zag) without cutting or decreased cutting of the rebar. Thus, in contrast to conventional rebar, the rebar of the present invention is more lightweight, flexible, and easy to use.

The rebar of the present invention is well suited for use in side walks, concrete walls, basement floors, roads, driveways retaining walls, flower gardens, and footings.

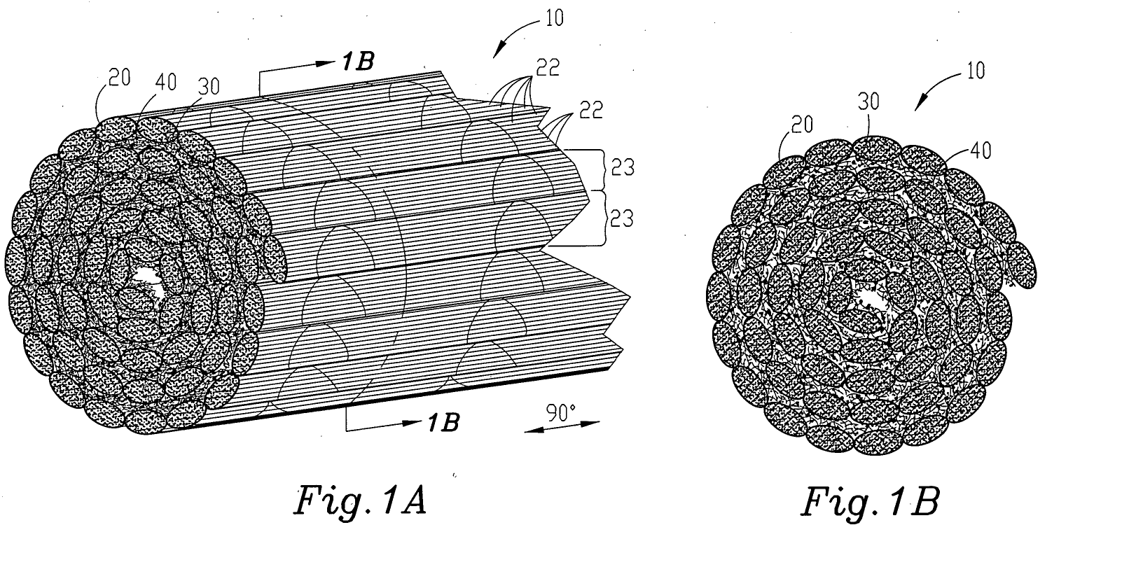

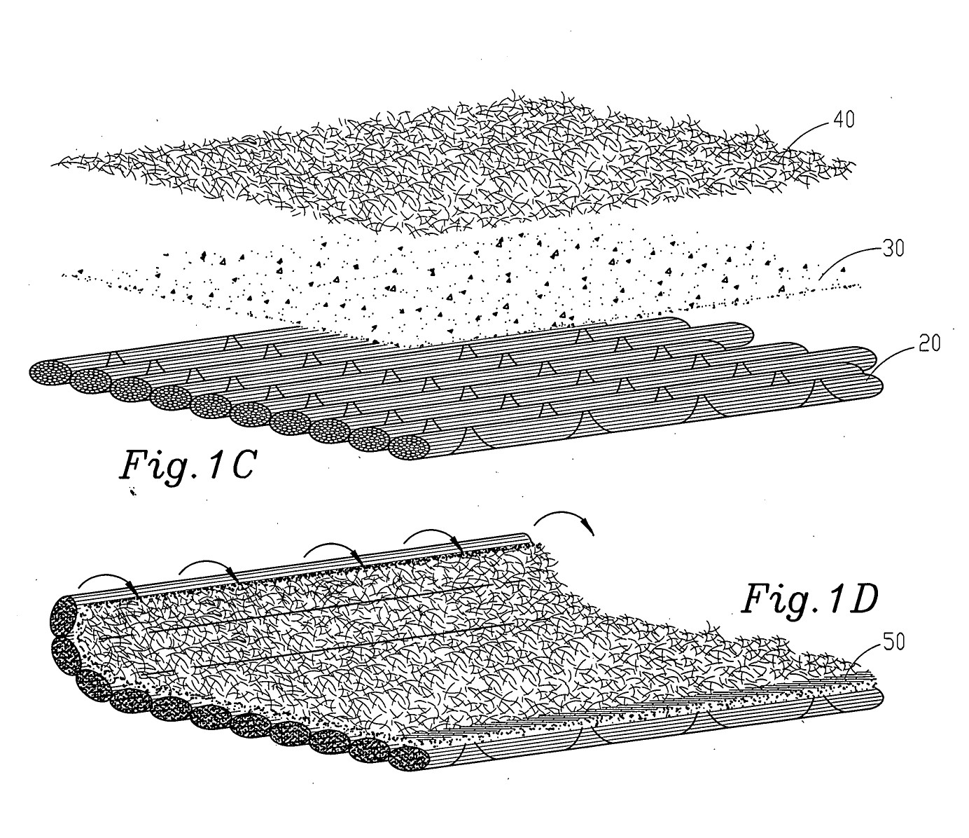

FIGS. 1A and 1B illustrate a first embodiment of the rebar 10 in accordance with the present invention. The rebar 10 comprises a rolled fibrous reinforcing member 20 having elongated fibers 22 and a hydraulic binder 30 embedded and dispersed therein. In addition, chopped fibers 40 may optionally be included in the rebar 10.

The fibrous reinforcing member 20 is preferably made of fiberglass and is comprised of elongated fiberglass fibers 22. In FIG. 1A, the preferred fibrous reinforcing member 20 comprises a unidirectional 12-ounce mat from Saint-Gobain Vetrotex America (Wichita Falls, Tex.) under the tradename CEM FIL® CM1708 that is rolled together, as discussed more fully below. It will be appreciated to those skilled in the fiber art that the preferred fibrous member 20 has a so-called coarse, matted, or woven side and a smooth or finished side in which the fibers are arranged in bundles 23. In the preferred embodiment, the course side faces the inside of the roll in FIGS. 1A and 1B, while the smooth side faces the outside of the roll.

For illustrative purposes, several individual fibers 22 in the bundles 23 of fiberglass are shown in the drawings. However, it will be appreciated to those skilled in the art that the bundles 23 may contain up to several hundreds or thousands of individual fibers 22. As illustrated by the arrows, the fibers 22 in the first embodiment preferably have a unidirectional 90° orientation.

The hydraulic binder 30 used in the rebar 10 illustrated in the first embodiment preferably comprises a Portland cement. More specifically the Portland cement is a type 1 Portland cement commercially available from Wichita Falls, Tex.

Chopped fibers 40 are optionally dispersed within the hydraulic binder 30, or provided in a layer above or below the binder. The chopped fibers 40 are preferably substantially the same material as the elongated fibers 22 of the fibrous reinforcing member 20 (e.g., both the fibers of the fibrous reinforcing member 20 and the chopped fibers 40 are fiberglass). In the preferred embodiment the chopped fibers 40 are comprised of fiberglass, such as: (1) 12 mm chopped strand (1/2 inch)-AR and/or (2) 6 mm chopped strand (1/4 inch)-AR, both commercially available from Saint-Gobain Vetrotex.

The rebar illustrated in FIGS. 1A and 1B is preferably constructed as shown in FIGS. 1C and 1D. First, hydraulic binder 30 is applied to at least a portion of an unrolled fibrous reinforcing member 20 as illustrated in FIG. 1C. In the case of a matted fibrous member, the hydraulic binder 30 is preferably applied to the woven side of the fibrous member 20. As shown in the drawings, the hydraulic binder (e.g., the cement) preferably covers substantially all of the unrolled fibrous reinforcing member 20 in a relatively uniform manner. Preferably, about 50 to 90% (and more preferably about 70 to 80%) of the total weight of the rebar 10 will be comprised of dry cement. A layer of chopped fibers 40 is then intermixed or layered with the hydraulic binder.

As shown in FIG. 1D, the rebar 10 of the present invention is prepared by rolling the fibrous reinforcing member 20 with the hydraulic binder 30 and optional chopped fibers 40 into a tight roll. The free end of the fibrous reinforcing member 20 is then fastened in a suitable manner well known to those skilled in the art. For example, the free end may be fastened with an adhesive, by stitching, or by bundling at periodic points. In the preferred embodiment, the free end is fastened using an adhesive 50 commercially available from the Minnesota Mining and Manufacturing Company under the tradename SUPER 77 or the spray adhesive AIRTAC2 commercially available from the Advanced Materials Group Airtech (Huntington Beach, Calif.).

Those skilled in the art will recognize that the rebar 10 of the present invention may be any suitable shape or size depending on its intended use. As such, the fibrous member 20 may be any suitable shape or size. The fibrous reinforcing member 20 is preferably about 2 to 36 inches wide (even more preferably about 4 to 6 inches wide) and about 12 inches to over 1000 feet long (even more preferably about 20 to 40 feet long).

The hydraulic binder 30 and chopped fibers 40 preferably cover substantially all of the fibrous reinforcing member 20 as illustrated in FIG. 1D. It also will be appreciated that these materials may cover a portion of the fibrous member 20. For example, the binder 30 and/or the chopped fibers 40 may be provided in periodic strips, blocks, or spots such that there are portions of the fibrous reinforcing member 20 that are not covered with cement. Likewise, the amount of hydraulic binder 30 and/or chopped fibers 40 may vary in amount from location to location such that there is more material at certain areas compared to others. As an example, the binder may be placed on the fibrous reinforcing member 20 so that when rolled, the binder is concentrated in the outer portion of the rolled fibrous reinforcing member 20.

Before the fibrous reinforcing member 20, hydraulic binder 30, and chopped fibers 40 are rolled together, the binder 30 and chopped fibers 40 are most preferably combined together in order to provide added strength to the rebar 10. Further, it will be appreciated that at least a portion of the hydraulic binder 30 may become integrated between the individual fibers 22 of the fibrous reinforcing member 20 itself.

Once rolled, the resulting rebar 10 comprises a fibrous reinforcing member 20 in which the binder 30 and the optional chopped fibers 40 are embedded and dispersed within the fibrous member by virtue of placement between the rolled layers of the fibrous reinforcing member. The phrase “embedded and dispersed” means, among other things, that the hydraulic binder forms an integral part of the rolled fibrous reinforcing member 20 itself in contrast to merely surrounding the outside of fibrous reinforcing member 20.

The rebar 10 of the present invention is flexible and light weight. As such, the elongated rebar 10 may be wound into a spool or roll lengthwise (not shown) and then unrolled as needed.

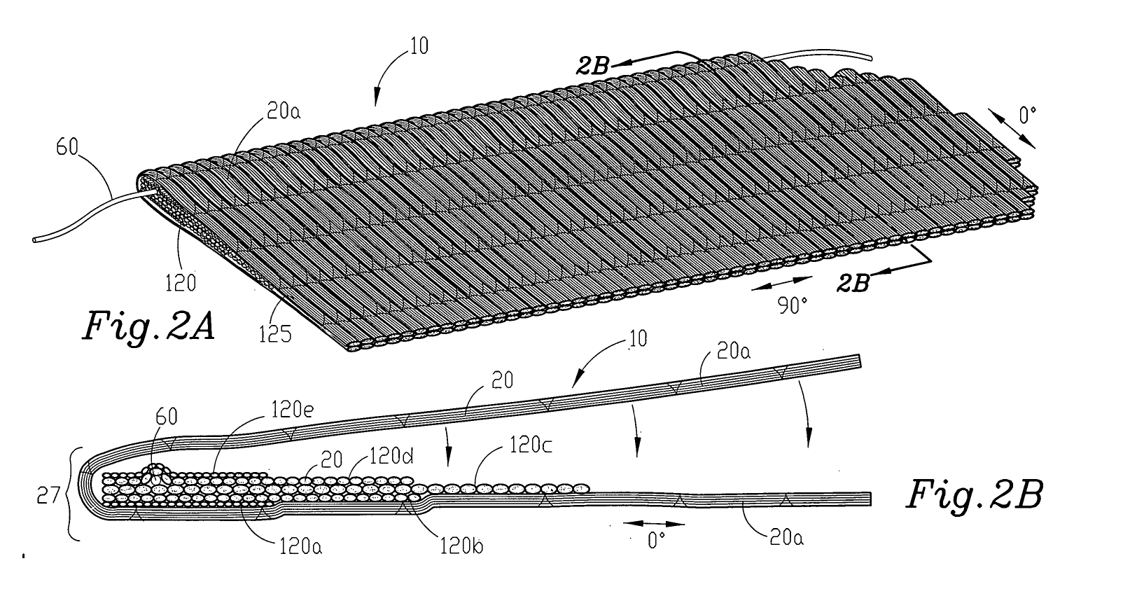

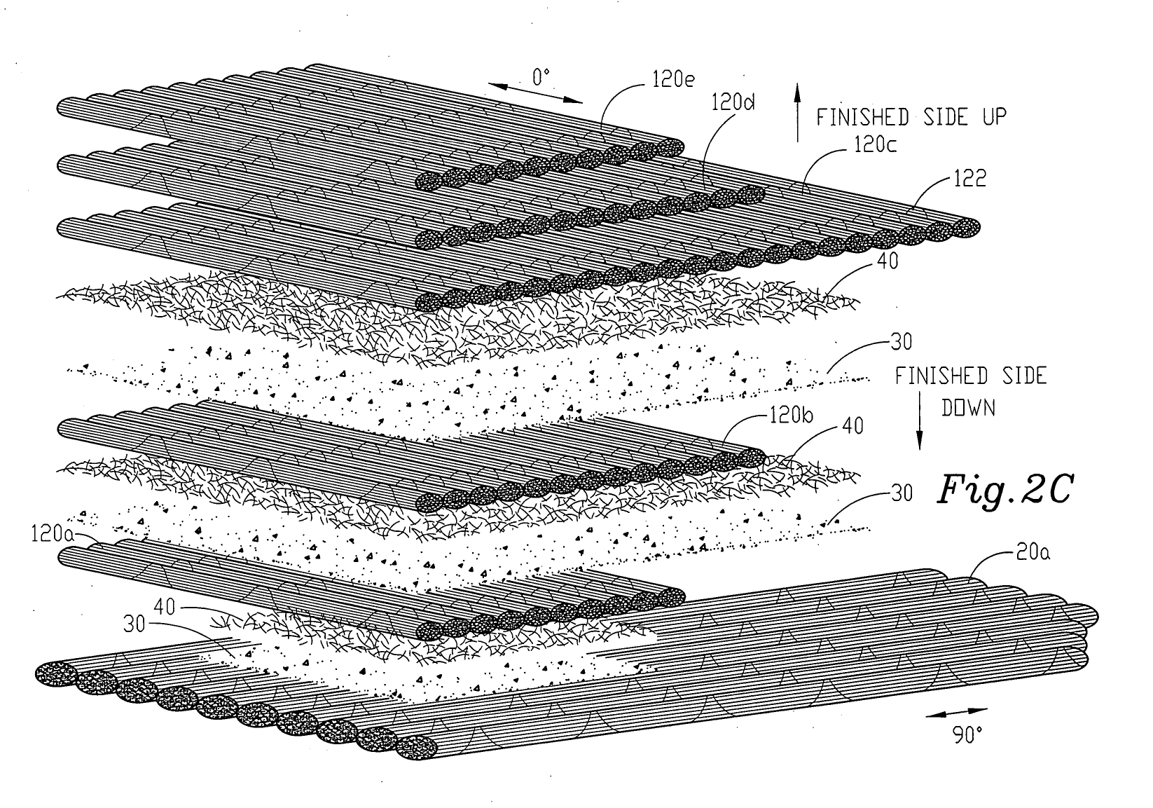

FIGS. 2A and 2B illustrate a rebar 10 in accordance with a second embodiment of the present invention. The rebar 10 comprises a fibrous reinforcing member 20 having an outer fibrous member 20a with one or more internal fibrous members 120a-e. The outer fibrous member 20a is preferably a unitary piece of fiberglass which is folded to form a cover-like structure for the internal fibrous members 120a-e. Stitching 125 is preferably used to fasten the ends of the outer fibrous member 20a to form the cover.

The fibers of the outer fibrous member 20a are preferably oriented differently than those of the internal fibrous members 120a-e. In the preferred embodiment, the fibers 22 of the folded outer fibrous member 20a are preferably oriented at a 0° angle while internal fibrous members 120a-e have their fibers 122 oriented at a 90° angle. It will be appreciated that a wide variety of fiber orientations are within the scope of the present invention.

As with the first embodiment, the rebar 10 of the second embodiment includes a hydraulic binder 30 and optionally chopped fibers 40 embedded and dispersed within the fibrous reinforcing member 20. FIG. 2C illustrates how these materials are preferably integrated into the composite rebar containing five internal fibrous members 120a, 120b, 120c, 120d, and 120e surrounded by the outer fibrous member 20a. First, an outer fibrous member 20a having suitable dimensions is provided. The unfolded outer fibrous member 20a preferably has a width larger than the width of the largest internal fibrous member 120 so that when folded, it covers substantially all of the internal members 120a-e as illustrated in FIG. 2B. The outer fibrous member is preferably about 1 to 12 inches wide, and even more preferably about 2 to 6 inches wide.

Hydraulic binder 30 and/or chopped fibers 40 are placed on the unfolded outer fibrous member 20a. Next, one or more internal fibrous members 120a, 120b, 120c, 120d, and 120e are positioned thereon. Additional hydraulic binder 30 and or/chopped fibers 40 are dispersed between some or all of the internal fibrous members 120a-e.

As illustrated in the drawings, the internal fibrous members 120a-e may have the same or different widths or lengths. The internal fibrous members 120a-e preferably have varying widths, the largest-width member being centered between consecutively smaller members as shown in FIGS. 2B and 2C. The internal fibrous members 120a-e preferably have a width ranging from about 0.25 to 6 inches wide. In the preferred embodiment, the width of the center internal fibrous member 120c is preferably about 0.5 to 1.5 inches, the width of adjacent internal fibrous members 120b, 120d are about ⅜ to 1.25 inches, and the width of the outer internal fibrous members 120a, 120e are about 0.25 to 1 inches.

The internal fibrous members 120a-e are positioned within in the outer fibrous member 20a in any suitable manner. In one embodiment, the ends of the internal members 120 are preferably substantially aligned at one end (see FIG. 2B) to facilitate folding of the outer fibrous member 20a along the folding area 27. In the preferred embodiment, the internal fibrous members 120a-e are also positioned so that the woven side and the finished side of the internal fibrous members 120a-e have certain alignments. For example, in one embodiment, the lower two internal fibrous members 120a and 120b shown in FIG. 2C are positioned with the finished side down and the woven side up, while the upper three internal fibrous members 120c, 120d, and 120e are positioned with the woven side down and the finished side up. Thus, at least two adjacent internal fibrous members are positioned with the woven side and finished side having the same orientation. This theoretically provides for better liquid absorption through the finished side during use.

The rebar 10 of the present invention also includes a cord 60 extending along all or a part of the rebar 10. The cord 60 is made of any suitable material. In the preferred embodiment, the cord is comprised of a fibrous material, such as nylon or other polymeric material. During use, the cord 60 is typically tied to a structural support or beam and used to guide the placement of the flexible rebar 10 in the desired pattern.

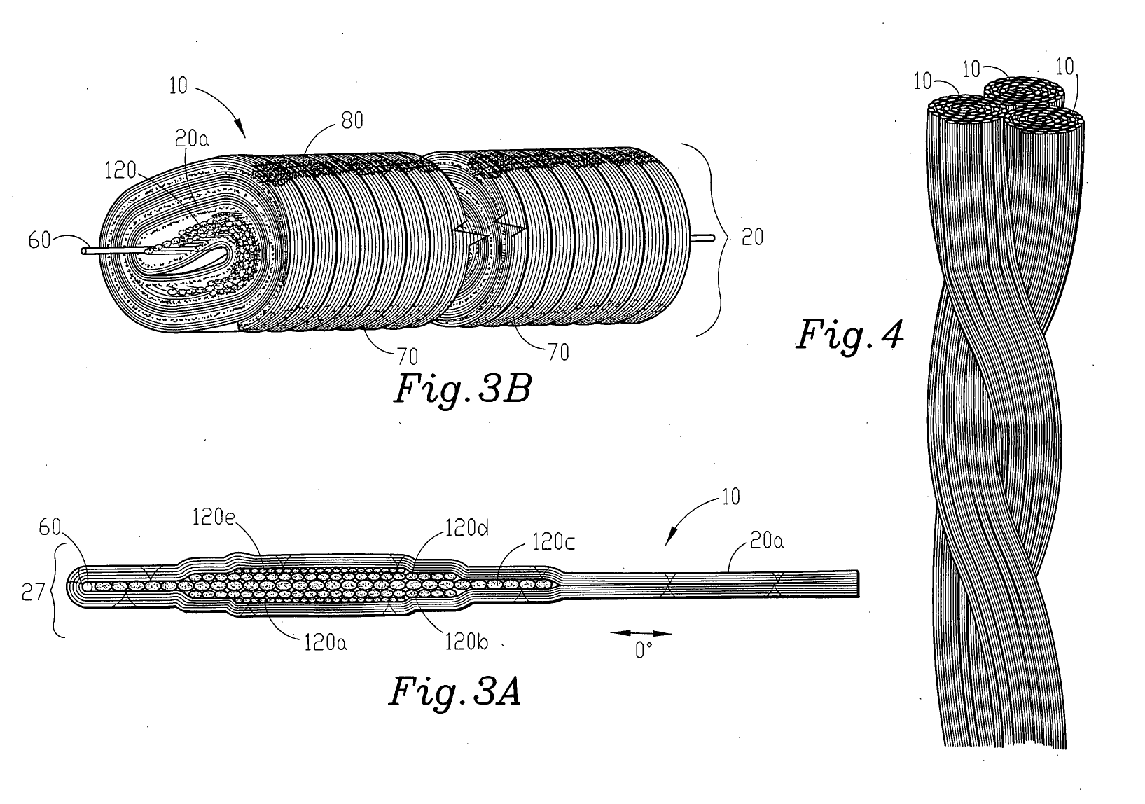

A third embodiment of the rebar of the present invention is illustrated in FIGS. 3A and 3B. In this embodiment, the rebar is comprised of an outer fibrous member 20a and one or more internal fibrous members 120a-e wound into a roll widthwise. The construction of the rebar of the third embodiment is similar to the rebar of the second embodiment except that the ends of the internal fibrous members 120a-e are not aligned at the folding area 27 but are instead displaced toward the center as illustrated in FIG. 3A. Further, unlike the second embodiment, after the outer fibrous member 20a is folded over the internal fibrous members 120a-e, the resulting structure is wound into a roll widthwise as shown in FIG. 3B. The free end of the roll may be fastened using any suitable means, such as with an adhesive, by stitching, or by bundling at periodic points.

In the third embodiment, hydraulic binder 30 and/or chopped fibers 40 are embedded and dispersed in the fibrous reinforcing member 20. During construction, the hydraulic binder 30 and/or chopped fibers are applied between one or more of the internal fibrous members 120a-e and/or on the outer fibrous member 20a shown in FIG. 3A prior to rolling. Thus, the phrase “embedded and dispersed” include placement between one or more of the internal fibrous members 120a-e. The phrase also includes placement on the outer fibrous member 20a so that when the structure is rolled as shown in FIG. 3B, the material is “embedded and dispersed” within layers of the outer fibrous member 20a.

As shown in FIG. 3B, the rebar 10 of the present invention also includes a water-impermeable sealant 70 coated on a portion of the rebar. The sealant preferably covers about one-eighth to one-half of the external surface area of the rebar, and even more preferably about one-fourth to one-third of the surface area. The preferred sealant is ELMER'S SPRAY ADHESIVE commercially available from Elmer's Product Inc. (Columbus, Ohio). The rebar 10 also includes include a colored marker 80, preferably located opposite to the sealant 70, which orientates the use as to which areas of the rebar contain sealant and which do not.

FIG. 4 illustrates how the one or more of the elongated structural rebars 10 of the present invention may be woven together to form a rope-like structure.

While specific embodiments have been shown and discussed, various modifications may of course be made, and the invention is not limited to the specific forms or arrangement of parts and steps described herein, except insofar as such limitations are included in the following claims. Further, it will be understood that certain features and sub-combinations are of utility and may be employed without reference to other features and sub-combinations. This is contemplated by and is within the scope of the claims.

1. An elongated structural rebar for reinforcing concrete material comprising:
a fibrous reinforcing member; and
a hydraulic binder embedded and dispersed within said fibrous reinforcing member.

2. The elongated structural rebar of claim 1 wherein said fibrous reinforcing member is comprised of a material selected from the group consisting of one or more of fiberglass, graphite, carbon, and aramid fibers.

3. The elongated structural rebar of claim 1 wherein said fibrous reinforcing member is comprised of fiberglass.

4. The elongated structural rebar of claim 3 wherein the fiberglass is alkaline-resistant.

5. The elongated structural rebar of claim 1 wherein fibrous reinforcing member comprises elongated fibers with a fiber orientation selected from the group consisting of 0° unidirectional, 90° unidirectional, +45/−45− double bias, °0°/90° biaxial longitudinal/transverse, °0°/90°/45° triaxial, 0°/+45°/−45° longitudinal triaxial, +45°/90°/−45° transverse triaxial, 0°/+45°/90°/−45° quadraxial, and 0°/−45°/90°/+45° quadraxial.

6. The elongated structural rebar of claim 1 wherein said fibrous reinforcing member comprises fibers woven with a weave selected from the group consisting of a bias, plain, twill, leno, heat set, long shaft satin, plain satin, basket, unidirectional and mock-leno weave.

7. The elongated structural rebar of claim 1 wherein said hydraulic binder comprises a Portland cement.

8. The elongated structural rebar of claim 1 wherein said hydraulic binder is also mixed with chopped fiberglass fibers.

9. The elongated structural rebar of claim 1 wherein said wherein said fibrous reinforcing member comprises a mat, woven material, or knitted material that is wound into a roll such that the hydraulic binder is embedded and dispersed within said roll.

10. The elongated structural rebar of claim 1 wherein said fibrous reinforcing member has a finished side and a woven side.

11. The elongated structural rebar of claim 1 wherein said rebar is wound into a spool or roll lengthwise.

12. The elongated structural rebar of claim 1 wherein at least a portion of said rebar is sealed with a sealant.

13. The elongated structural rebar of claim 12 wherein at least a portion of said rebar has a colored marker thereon.

14. The elongated structural rebar of claim 13 wherein said colored marker is opposite said sealant.

15. The elongated structural rebar of claim 1 wherein the fibrous reinforcing member is sized within a fluorine-containing chemical that renders the member non-biodegradable.

16. The elongated structural rebar of claim 1 further comprising a cord extending along all or a part of the rebar lengthwise.

17. The elongated structural rebar of claim 16 wherein said cord is comprised of nylon.

18. The elongated structural rebar of claim 1 wherein said fibrous reinforcing member includes at least one outer fibrous member at least partially surrounding one or more internal fibrous members.

19. The elongated structural rebar of claim 18 wherein said fibrous reinforcing member includes a plurality of internal fibrous members, at least one of the internal fibrous members having a width different from one or more of the other internal fibrous members.

20. The elongated structural rebar of claim 19 wherein at least two internal fibrous members each have a woven side and a finished side, and wherein at least two adjacent internal fibrous members are positioned with the woven side and finished side having the same orientation.

21. The elongated structural rebar of claim 18 wherein chopped fibers are provided between one or more of the internal fibrous members.

22. The elongated structural rebar of claim 18 wherein said hydraulic binder is provided between one or more of the internal fibrous members.

23. The elongated structural rebar of claim 18 wherein the outer fibrous member and said internal fibrous members each have a plurality of fibers, the fibers of said outer fibrous member being oriented different than those of said internal fibrous member.

24. The elongated structural rebar of claim 23 wherein the fibers of the outer fibrous member are oriented at a 0° angle and said fibers of said internal fibrous members are oriented at a 90° angle.

25. A method of constructing a structural rebar for reinforcing concrete, said method comprising:
providing a fibrous reinforcing member having a plurality of fibers; and
embedding and dispersing a hydraulic binder within said fibrous reinforcing member.

26. The method of constructing a structural rebar of claim 25 wherein said fibrous reinforcing member is comprised of a material selected from the group consisting of one or more of fiberglass, graphite, carbon, and aramid fibers.

27. The method of constructing a structural rebar of claim 25 wherein said fibrous reinforcing member is comprised of fiberglass.

28. The method of constructing a structural rebar of claim 27 wherein the fiberglass is alkaline-resistant.

29. The method of constructing a structural rebar of claim 25 wherein the reinforcing member comprises elongated fibers with a fiber orientation selected from the group consisting of 0° unidirectional, 90° unidirectional, +45/−45− double bias, °0°/90° biaxial longitudinal/transverse, °0°/90°/45° triaxial, 0°/+45°/−45° longitudinal triaxial, +45°/90°/−45° transverse triaxial, 0°/+45°/90°/−45° quadraxial, and 0°/−45°/90°/+45° quadraxial.

30. The method of constructing a structural rebar of claim 25 wherein said fibrous reinforcing member comprises fibers woven with a weave selected from the group consisting of a bias, plain, twill, leno, heat set, long shaft satin, plain satin, basket, unidirectional and mock-leno weave.

31. The method of constructing a structural rebar of claim 25 wherein said hydraulic binder comprises a Portland cement.

32. The method of constructing a structural rebar of claim 25 further comprising the step of embedding and dispersing chopped fibers within said fibrous reinforcing member.

33. The method of constructing a structural rebar of claim 25 further comprising the step of sealing at least a portion of said rebar with a sealant.

34. The method of constructing a structural rebar of claim 33 further comprising the step of marking said rebar with a marker to orient said sealant.

35. The method of constructing a structural rebar of claim 25 further comprising the step of sizing the fibrous reinforcing member with a fluorine-containing chemical that renders the member non-biodegradable.

36. The method of constructing a structural rebar of claim 25 further comprising the step of extending a cord along all or a part of the rebar lengthwise.

37. The method of constructing a structural rebar of claim 25 wherein said fibrous reinforcing member is initially unrolled, and said embedding and dispersing step comprises providing said hydraulic binder on said at least a portion of said unrolled fibrous reinforcing member, and then rolling said fibrous reinforcing member into a roll.

38. The method of constructing a structural rebar of claim 25 wherein said fibrous reinforcing member comprises an outer fibrous member surrounding at least partially a plurality of internal fibrous members, and wherein said embedding and dispersing step comprises providing said hydraulic binder between said internal fibrous members.

39. The method of constructing a structural rebar of claim 38 wherein said hydraulic binder is further provided between at least one internal fibrous member and said outer fibrous member.

40. The method of constructing a structural rebar of claim 25 wherein said fibrous reinforcing member includes a plurality of internal fibrous members, at least one of the internal fibrous members having a width different from one or more of the other internal fibrous members.

41. The method of constructing a structural rebar of claim 38 wherein chopped fibers are provided between one or more of the internal fibrous members.

42. A method for reinforcing concrete, said method comprising:
providing an elongated structural rebar comprised of a fibrous reinforcing member having a plurality of fibers and a hydraulic binder embedded and dispersed within said fibrous reinforcing member;
providing a wetted cement adjacent to said elongated structural rebar; and
permitting said wetted cement to dry into concrete that is reinforced by said rebar.
